(19) United States
(12) Patent Application Publication
(10) Pub. No.: US 2015/0002409 A1
(43) Pub. Date: Jan. 1, 2015

(54) ELECTRONIC APPARATUS AND METHOD FOR CONTROLLING THE SAME

(71) Applicant: Wistron Corp., New Taipei City (TW)

(72) Inventors: Chang-Long Hsu, New Taipei City (TW); Rui-Yi Chen, New Taipei City (TW)

(73) Assignee: Wistron Corp., New Taipei City (TW)

(21) Appl. No.: 14/094,661

(22) Filed: Dec. 2, 2013

(30) Foreign Application Priority Data
Jul. 1, 2013 (TW) 102123424

(51) Int. Cl. G06F 1/16; G06F 3/041

(52) U.S. Cl. CPC G06F 1/1618; G06F 3/041
USPC 345/173

(57) ABSTRACT

A convertible computer is provided. The convertible computer includes: a base housing, a touch housing, and a hinge unit. The base housing is equipped with a built-in control module for determining an angle between the base housing and the touch housing according to rotation of the hinge unit, and controlling the touch screen unit and the electrochromic unit according to the determined angle. When the angle exceeds a preset opening angle, the built-in control module enables the electrochromic unit to present a virtual keyboard, and the built-in control module receives inputs corresponding to manipulation of the virtual keyboard. When the angle is less than a preset closing angle, the built-in control module enables the touch screen unit, and the built-in control module receives inputs corresponding to manipulation of the touch screen unit.

### CROSS REFERENCE TO RELATED APPLICATIONS

This application claims priority of Taiwan Patent Application Ser. No. 102123424, filed 2013 Jul. 1, entitled ELECTRONIC APPARATUS AND METHOD FOR CONTROLLING THE SAME. The contents of this application are hereby incorporated by reference.

### BACKGROUND OF THE INVENTION

1. Field of the Invention

The present invention relates to an electronic apparatus, and in particular, to an electronic apparatus and method for controlling the same, wherein the electronic apparatus can be utilized both as a tablet and a laptop.

2. Description of the Related Art

Recently, electronic devices that can be utilized both as a tablet computer and a laptop computer are being marketed widely (hereinafter referred to as a convertible computer). The existing convertible computer is equipped with a complex hinge, which operates to pivot a display housing relative to a base housing and to convert the computer to a tablet computer or a laptop computer.

For example, one type of the existing convertible computer has a base housing and a display housing, wherein the base housing and the display housing are connected via a hinge. A keyboard module is mounted on the base housing. The display housing pivots relative to the base housing. When the display housing is opened at an angle around 90 degrees relative to the base housing, the computer operates as a laptop computer. On the other hand, when the display housing is opened at an angle around 180 degrees comparable the base housing, with a display screen facing upward, the computer operates as a tablet computer. The existing convertible computer converts via complex hinges and rotation members. These hinges and rotation members are expensive to manufacture and inconvenient to use.

Accordingly, there is a need for a convertible computer that can be utilized both as a tablet computer and a laptop computer via a convenient conversion mechanism.

### BRIEF SUMMARY OF THE INVENTION

A detailed description is given in the following embodiments with reference to the accompanying drawings.

In an exemplary embodiment, a convertible computer is provided. The convertible computer includes a base housing, a touch housing, and a hinge unit. The base housing is equipped with a built-in control module, a display surface and a base-housing frame, wherein a display screen is mounted on the display surface. The touch housing includes a touch panel unit, an electrochromic unit, and a touch-housing frame. The hinge unit is attached to confronting edge portions of the base-housing frame and the touch-housing frame in order to connect the base housing and the touch housing. The built-in control module determines an angle between the base housing and the touch housing according to the rotation of the hinge unit, and controls the touch screen unit and the electrochromic unit according to the determined angle. When the angle exceeds a preset opening angle, the built-in control module enables the electrochromic unit to present a virtual keyboard, and the built-in control module receives inputs corresponding to manipulation of the virtual keyboard. When the angle is less than a preset closing angle, the built-in control module enables the touch screen unit, and the built-in control module receives inputs corresponding to manipulation of the touch screen unit.

In the above convertible computer, the display screen is a liquid-crystal display screen. In addition, the touch screen unit includes a resistive touch screen or a capacitive touch screen.

In the above convertible computer, when the built-in control module enables the electrochromic unit, electric power is supplied to the electrochromic unit, and the electrochromic unit presents the virtual keyboard on an upward-facing surface of the base housing.

In the above convertible computer, when the built-in control module enables the electrochromic unit, electric power is supplied to the electrochromic unit, and the electrochromic unit presents a virtual touch pad on the upward-facing surface of the base housing.

In another exemplary embodiment, a method for controlling a convertible computer is provided. The convertible computer includes a base housing, a touch housing, and a hinge unit. The base housing is equipped with a built-in control module, a display surface and a base-housing frame, wherein a display screen is mounted on the display surface. The touch housing has a touch panel unit, an electrochromic unit, and a touch-housing frame. The hinge unit is attached to edge portions of the base-housing frame and the touch-housing frame in order to connect the base housing and the touch housing. The method includes the following steps: determining an angle between the base housing and the touch housing according to the rotation of the hinge unit, and controlling the touch screen unit and the electrochromic unit according to the determined angle; when the determined angle exceeds a preset opening angle, enabling the electrochromic unit to present a virtual keyboard, and receiving inputs corresponding to manipulation of the virtual keyboard; when the angle is less than a preset closing angle, enabling the touch screen unit, and receiving inputs corresponding to manipulation of the touch screen unit.

In the above method, when enabling the electrochromic unit, electric power is to the electrochromic unit, and the electrochromic unit presents the virtual keyboard on an up-facing surface of the base housing.

In the above method, when enabling the electrochromic unit, electric power is supplied to the electrochromic unit, and the electrochromic unit presents a virtual touch pad on an up-facing surface of the base housing.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating a convertible computer according to an embodiment of the invention;

FIG. 2 is a schematic diagram illustrating a convertible computer utilized as a tablet computer according to an embodiment of the invention;

FIG. 3 is a schematic diagram illustrating a convertible computer utilized as a laptop computer according to an embodiment of the invention;

FIG. 4 illustrates a block diagram of a control module which is built in a convertible computer according to an embodiment of the invention; and

FIG. 5 is a flowchart illustrating the method for controlling a convertible computer according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

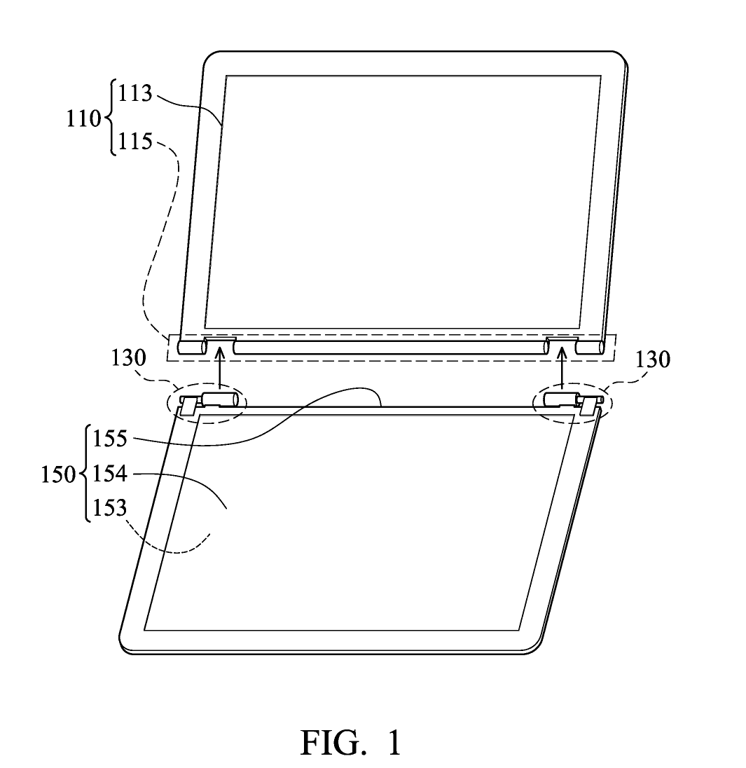

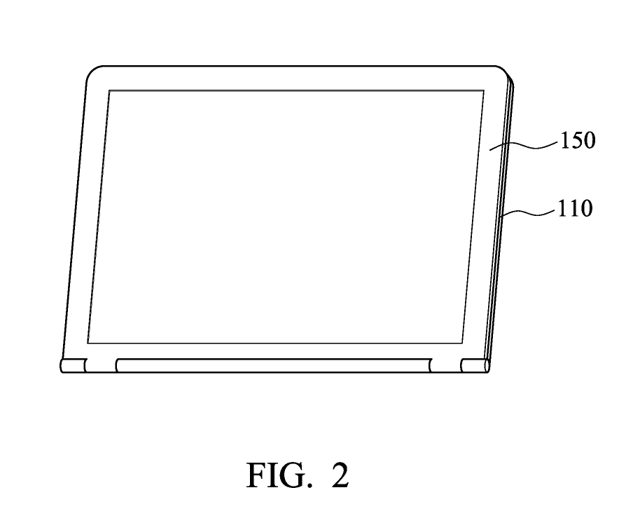

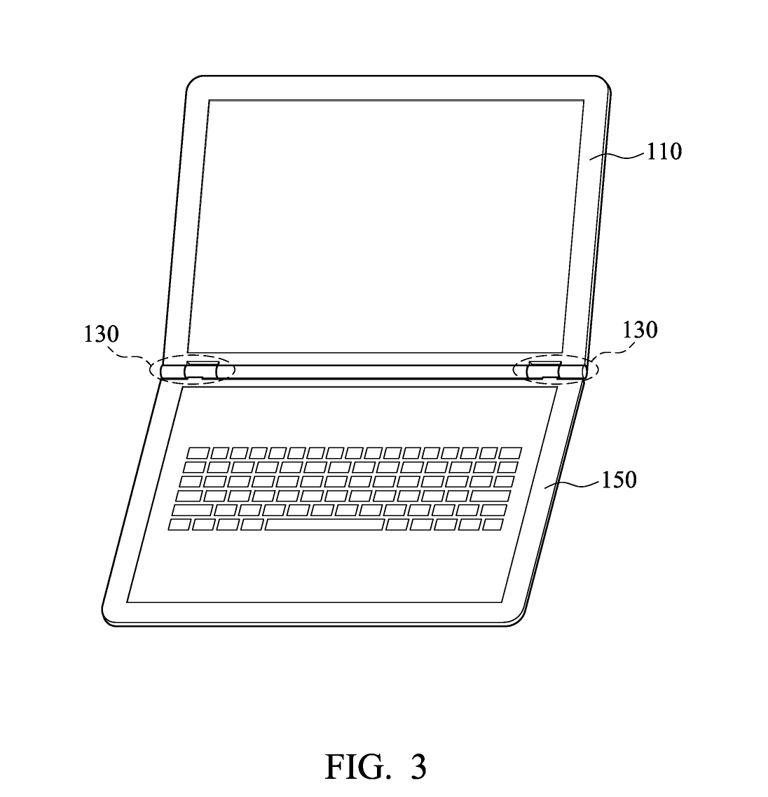

FIG. 1 is a schematic diagram illustrating a convertible computer according to embodiment of the invention; FIG. 2 is a schematic diagram illustrating a convertible computer utilized as a tablet computer according to an embodiment of the invention; and FIG. 3 is a schematic diagram illustrating a convertible computer utilized as a laptop computer according to an embodiment of the invention. In order to provide a concise explanation of the present invention, only elements substantially pertaining to conversion between a tablet computer and a laptop computer are illustrated in FIG. 1, and elements which are not substantially pertaining to conversion between a tablet computer and a laptop computer are omitted.

According to an embodiment, an electronic device 100 includes a base housing 110, a touch housing 150, and a hinge unit 130.

The base housing 110 has a platelike shape and is equipped with a built-in control module (not shown in FIG. 1). In outward appearance, the platelike base housing 110 has a front planar surface and a back planar surface, and base-housing frames surrounding edges of the planar surfaces. The front planar surface shown in FIG. 1 is a display surface. A display screen 113 is mounted on the display surface. The display screen 113 displays related graphics, data, and interfaces. The back planar surface is not shown in FIG. 1. In this embodiment, the display screen 113 is a display screen, such as an LCD screen, which is not touch-sensitive. One of the base-housing frames is referred to as a base-housing frame 115, which is connected to the hinge unit 130 for connecting the base housing 110 and the touch housing 150 via the hinge unit 130.

Similar to the base housing 110, the touch housing 150 has a platelike shape. In addition, the base housing 110 and the touch housing 150 have essentially the same size and shape, thus the touch housing 150 can be opened at different angles comparable to the base housing 110. The platelike touch housing 150 has a touch panel unit 153, an electrochromic unit 154, and touch-housing frames. The touch panel unit 153 and the unit 154 have the same size and are congruent and are superimposed together. One of the touch-housing frames (hereinafter referred to as touch-housing frame 155) is connected to the hinge unit 130 in order to connect the base housing 110 and the touch housing 150.

The hinge unit 130 is attached to confronting edge portions of the base-housing frame 115 and the touch-housing frame 155 in order to connect the base housing 110 and the touch housing 150.

According to an embodiment, when the touch housing 150 is superimposed on the base housing 110 (i.e., the display surface of the base housing 110 is overlaid by the touch housing 150), the touch panel unit 153 is superimposed on the display screen 113 of the base housing 110. By superimposing the touch panel unit 153 on the display screen 113, the display screen 113 is enabled and a tablet configuration is achieved. In the tablet configuration, the touch panel unit 153 is transparent, and the enabled display screen 113 displays data to a user through the transparent touch panel unit 153. In addition, in the tablet configuration, the user may write on or tap the touch panel unit 153 using a stylus or other implement, such as a finger. The display screen 113 and the touch panel unit 153 overlaid on the display screen 113 operate as a touch-sensitive display screen. In the tablet configuration, the electronic device 100 is utilized as a tablet computer, as shown in FIG. 2.

The touch housing 150 may rotate about the hinge unit 130 to change the electronic device 100 from the tablet configuration to a laptop configuration. As shown in FIG. 3, the touch housing 150 rotates about the hinge unit 130 and stays in a status under which an angle between the touch housing 150 and the base housing 110 is about equal to or greater than 90 degrees. When the angle exceeds a preset opening angle (for example, 90 degrees), the electrochromic unit 154 is enabled to present a virtual keyboard. Inputs corresponding to manipulation of the virtual keyboard are received corresponding to user on the virtual keyboard. In the laptop configuration, the virtual keyboard displayed by the electrochromic unit 154 serves as an input device of the electronic device 100, and the display screen 113 serves as a display device of the electronic device 100. In the laptop configuration, the electronic device 100 is utilized as a laptop computer, as shown in FIG. 3.

In addition, a virtual touch pad is presented by the electrochromic unit 154 when the electrochromic unit 154 is enabled. The user can tap on the virtual touch pad to implement curser moving, single clicking, double clicking or other operations that are traditionally implemented using a mouse.

The electrochromic unit 154 is enabled when a burst of charge is applied to the electrochromic unit 154. When the electrochromic unit 154 is enabled, a phenomenon called “electrochromism” is displayed by the electrochromic unit 154. When enabled, the electrochromic unit 154 displays a virtual keyboard and/or a virtual touch pad that are formed by materials painted on the electrochromic unit 154. The materials can change color when energized by an electrical current. Essentially, electricity kicks off a chemical reaction in this sort of material. This reaction changes the properties of the material. In this embodiment, the reaction changes the way the material reflects and absorbs light. In some electrochromic materials, the change is between different colors. In the electrochromic unit 154, the material changes between colored (reflecting light of some color) and transparent (not reflecting any light). The use of electrochromic materials and electrochromism is a known technique, and therefore details thereof are not described here.

Referring to FIG. 1, the electronic device 100 is shown as two separate parts (the base housing 110 and the touch housing 150), and the hinge unit 130 is illustrated as connecting to the touch housing 150. The illustration is not to be taken in a limiting sense. The base housing 110, touch housing 150 and hinge unit 130 can be connected in other ways.

Operation of the electrochromic unit 154 and the touch panel unit 153 is controlled by a control module (not shown in FIG. 1). The control module determines an angle between the base housing and the touch housing according to rotation of the hinge unit, and controls the touch screen unit 153 and the electrochromic unit 154 according to the determined angle. When the angle exceeds a preset opening angle, the control module enables the electrochromic unit 154 to present a virtual keyboard, and the control module receives inputs corresponding to manipulation of the virtual keyboard. On the other hand, when the angle is less than a preset closing angle, the control module enables the touch screen unit 153 and disables the electrochromic unit 154, and the control module receives inputs corresponding to manipulation of the touch screen unit 153.

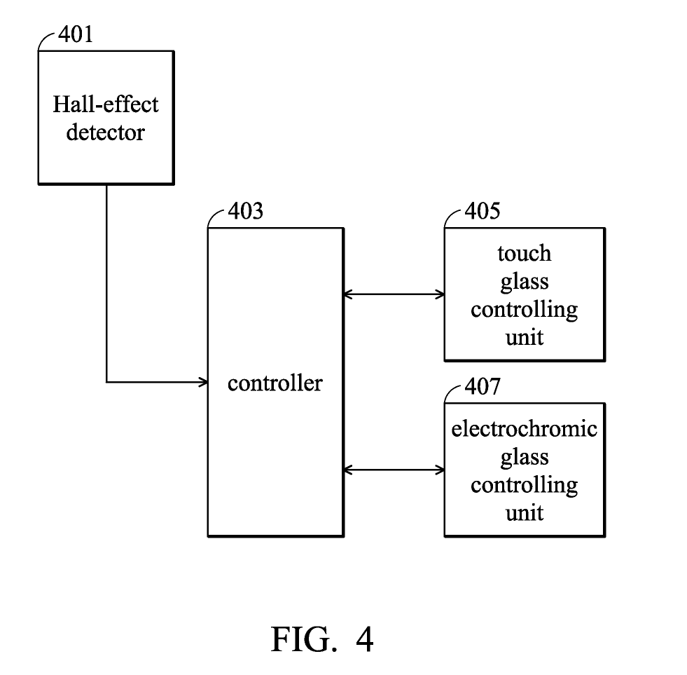

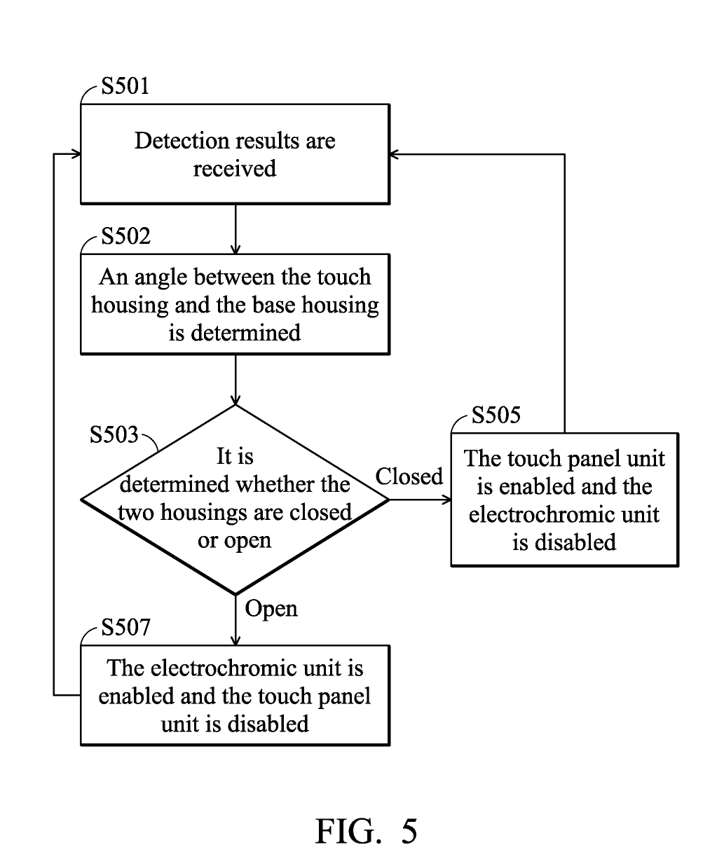

FIG. 4 illustrates a block diagram of a control module which is built in a convertible computer according to an embodiment of the invention. In addition, FIG. 5 is a flowchart illustrating the method for controlling a convertible computer according to an embodiment of the invention.

Referring to FIG. 4, the controller 403 is electrically connected to a Hall-effect detector 401, a touch glass controlling unit 405 and an electrochromic glass controlling unit 407.

The Hall-effect detector 401 is used for detecting an angle between the touch housing 150 and the base housing 110, and for transferring the results of this detection to the controller 403.

Based on the detected angle, the controller 403 generates controlling signals to the touch glass controlling unit 405 and electrochromic glass controlling unit 407 in order to alternatively enable the electrochromic unit 154 and the touch panel unit 153.

When the angle exceeds a preset opening angle, the control module transmits enabling signal to the electrochromic glass controlling unit 407 in order to enable the electrochromic unit 154 to present a virtual keyboard. In addition, a disabling signal is transmitted to the touch glass controlling unit 405 in order to disable the touch panel unit. The electrochromic glass controlling unit 407 applies a burst of charge to the electrochromic unit in response to the enabling signal. The electrochromic unit presents a virtual keyboard and a virtual touch pad when the burst of charge is applied. Inputs are received corresponding to manipulation of the virtual keyboard and a virtual touch pad.

Conversely, when the angle is less than a preset closing angle, an enabling signal is transmitted to the touch glass controlling unit 405 in order to enable the touch panel unit. In addition, the control module transmits a disabling signal to the electrochromic glass controlling unit 407 in order to disable the electrochromic unit. The touch glass controlling unit 405 enables the touch screen unit 153 in response to the enabling signal, thus inputs are received according to manipulation of the touch panel unit.

The method illustrated in FIG. 3 can be implemented by the control module. While the process flow described below includes a number of operations that appear to occur in a specific order, it should be apparent that these processes may include more or fewer operations, which may be executed serially or in parallel (for example, using parallel processors or a multi-threading environment).

In step S501, detection results are received from the Hall-effect detector.

In step S502, an angle between the touch housing and the base housing is determined according to the detecting results received in step S501.

In step S503, it is determined whether the two housings (i.e., the touch housing and the base housing) are closed or open. For example, when the angle is less than a preset closing angle, it is determined that the two housings are closed or are closing; when the angle exceeds a preset opening angle, it is determined that the two housings are open or are

In step S505, when the two housings are closed or are closing, the touch panel unit is enabled and the electrochromic unit is disabled, thus the electronic device is utilized as a tablet computer.

In step S507, when the two housings are open or are opening, the electrochromic unit is enabled and the touch panel unit is disabled, thus the electronic device is utilized as a laptop computer.

According to this embodiment, when the two housings are closed or are closing, (i.e., the touch housing is superimposed on the base housing and the display surface of the base housing is overlaid by the touch housing), the touch panel unit is superimposed on the display screen of the base housing. By superimposing the touch panel unit on the display screen, the display screen is enabled and a tablet configuration is achieved. In the tablet configuration, the touch panel unit is transparent, and the enabled display screen displays data to a user through the transparent touch panel unit. In addition, in the tablet configuration, the user may write on or tap the touch panel unit using a stylus or other implement, such as a finger. The display screen and the touch panel unit overlaid on the display screen operate as a touch-sensitive display screen. In the tablet configuration, the electronic device 100 is utilized as a tablet computer.

The touch housing may rotate about the hinge unit to change the electronic device from the tablet configuration to a laptop configuration. The touch housing rotates about the hinge unit and stays in a status under which an angle between the touch housing 150 and the base housing is about equal to or greater than 90 degrees. When the angle exceeds a preset opening angle (for example, 90 degrees), the electrochromic unit is enabled to present a virtual keyboard. Inputs corresponding to manipulation of the virtual keyboard are received corresponding to user operation on the virtual keyboard. In the configuration, the virtual keyboard displayed by the electrochromic unit serves as an input device of the electronic device, and the display screen serves as a display device of the electronic device. In the laptop configuration, the electronic device 100 is utilized as a laptop computer.

The present invention provides, without using complex structures, an electronic device that can be converted between a tablet computer and a laptop computer.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A convertible computer, comprising:
a base housing, equipped with a built-in control module, a display surface and a base-housing frame, wherein a display screen is mounted on the display surface;
an touch housing, having a touch panel unit, an electrochromic unit, and a touch-housing frame; and
a hinge unit, attached to confronting edge portions of the base-housing frame and the touch-housing frame in order to connect the base housing and the touch housing;
wherein:
the built-in control module determines an angle between the base housing and the touch housing according to rotation of the hinge unit, and controls the touch screen unit and the electrochromic unit according to the determined angle;
when the angle exceeds a preset opening angle, the built-in control module enables the electrochromic unit to present a virtual keyboard, and the built-in control module receives inputs corresponding to manipulation of the virtual keyboard; and
when the angle is less than a preset closing angle, the built-in control module enables the touch screen unit, and the built-in control module receives inputs corresponding to manipulation of the touch screen unit.

2. The convertible computer of claim 1, wherein the display screen is a liquid-crystal display (LCD) screen.

3. The convertible computer of claim 1, wherein when the built-in control module enables the electrochromic unit, electric power is supplied to the electrochromic unit, and the electrochromic unit presents the virtual keyboard on an up-facing surface of the base housing.

4. The convertible computer of claim 1, wherein when the built-in control module enables the electrochromic unit, electric power is supplied to the electrochromic unit, and the electrochromic unit presents a virtual touch pad on an up-facing surface of the base housing.

5. The convertible computer of claim 1, wherein the touch screen unit comprises a resistive touch screen or a capacitive touch screen.

6. A method for controlling a convertible computer, wherein the convertible computer comprises:
a base housing having a display surface and a base-housing frame, wherein a display screen is mounted on the display surface;
an touch housing having a touch panel unit, an electrochromic unit, and a touch-housing frame; and
a hinge unit, attached to confronting edge portions of the base-housing frame and the touch-housing frame in order to connect the base housing and the touch housing;
wherein the method comprises the following steps:
determining an angle between the base housing and the touch housing according to rotation of the hinge unit,
controlling the touch screen unit and the electrochromic unit according to the determined angle;
when the determined angle exceeds a preset opening angle, enabling the electrochromic unit to present a virtual keyboard, and receiving inputs corresponding to manipulation of the virtual keyboard;
when the angle is less than a preset closing angle, enabling the touch screen unit, and receiving inputs corresponding to manipulation of the touch screen unit.

7. The method for controlling a convertible computer of claim 6, wherein when enabling the electrochromic unit, electric power is supplied to the electrochromic unit, and the electrochromic unit presents the virtual keyboard on an up-facing surface of the base housing.

8. The method for controlling a convertible computer of claim 6, wherein when enabling the electrochromic unit, electric power is supplied to the electrochromic unit, and the electrochromic unit presents a virtual touch pad on an up-facing surface of the base housing.
